(19) United States
(12) Patent Application Publication
(10) Pub. No.: US 2025/0174996 A1
(43) Pub. Date: May 29, 2025

(54) METHOD AND SYSTEM FOR TRACKING THE OSCILLATION PATH OF A DIRECT DRIVE WIND FARM

(71) Applicant: NORTH CHINA ELECTRIC POWER UNIVERSITY, Beijing (CN)

(72) Inventors: Jing MA, Beijing (CN); Xi SHI, Beijing (CN); Yaqi SHEN, Beijing (CN); Yawen DENG, Beijing (CN)

(73) Assignee: NORTH CHINA ELECTRIC POWER UNIVERSITY, Beijing (CN)

(21) Appl. No.: 18/769,242

(22) Filed: Jul. 10, 2024

(30) Foreign Application Priority Data
Nov. 23, 2023 (CN) 202311572498.4

(51) Int. Cl. H02J 3/24; F03D 7/02; F03D 7/04; F03D 9/25; H02J 3/38

(52) U.S. Cl. CPC H02J 3/24; F03D 7/0272; F03D 7/048; H02J 3/381; F03D 9/255; H02J 2203/10; H02J 2203/20; H02J 2300/28

(57) ABSTRACT

A method and system for tracking the oscillation path of a direct drive wind farm involve: collecting the port current, the current and state variables of the current inner loop, the dynamic angle and state component of the phase-locked loop and the phase and amplitude of the fault point voltage of each wind turbine generator in a dominant oscillation mode period which is used as acquisition period, and then obtaining corresponding instantaneous value of each oscillation component of the direct drive wind turbine generator; obtaining energy flow of coupling energy transfer path of direct drive wind farm in each acquisition period based on the instantaneous value; tracking the key energy transfer path of the direct drive wind farm according to the energy flow, so as to realize the stability control of the direct drive wind farm.

### CROSS-REFERENCE TO RELATED APPLICATIONS

This application claims priority to Chinese Patent Application No. 202311572498.4, filed on Nov. 23, 2023, which is hereby incorporated by reference in its entirety.

### TECHNICAL FIELD

The application relates to the technical field of wind power generation system, in particular to a direct drive wind farm oscillation path tracking method and system.

### BACKGROUND

With the increase of grid-connected capacity of large-scale direct drive wind farms, the dynamic characteristics of the power system have changed greatly, and the interaction between multiple control links of direct drive wind farms may lead to oscillations after the system is disturbed, and even cause system-level accidents. Therefore, it is very important to clarify the interaction modes within the wind farm or between the wind farm and the power grid, reveal the influence mechanism of each interaction on the oscillation instability of the system, and determine the key energy transfer path that induces the oscillation of the system, so as to reduce the impact of the grid-connected system of the direct drive wind farm.

At present, the analysis methods for the sub/super-synchronous oscillation problem of direct drive wind farms mainly rely on linearized small signal models. However, due to the dynamic change of the operating equilibrium point of the system, the key energy transfer path of the grid-connected system of direct drive wind farms cannot be accurately and effectively tracked, which has an impact on the stability assessment. The conclusions obtained are not of general guiding significance.

### SUMMARY

In view of the above analysis, the embodiment of the application aims to provide a method and system for tracking the oscillation path of a direct drive wind farm, so as to solve the problem that the key energy transfer path of a direct drive wind farm grid-connected system cannot be accurately and effectively tracked in the prior art.

In one aspect, the application provides a method for tracking the oscillation path of a direct drive wind farm, including the following steps:

when a direct drive wind farm fails, the dominant oscillation mode period is used as the acquisition period to collect the port current, current and state variables of the current inner loop, the dynamic angle and state component of the phase-locked loop, and the phase and amplitude of the fault point voltage, and then the corresponding instantaneous value of each oscillation component of the direct drive wind farm is obtained;

based on the instantaneous value of each oscillation component collected in each acquisition period, the energy flow of the coupling energy transfer path of the direct drive wind farm in each acquisition period is obtained;

according to the energy flow of the coupling energy transfer path of the direct drive wind farm in each acquisition period, the key energy transfer path of the direct drive wind farm is tracked, and then the stability control of the direct drive wind farm is realized.

Further, the energy flow of the coupling energy transfer path between subsystems of the direct drive wind farm in each acquisition period is obtained by the following methods:

based on the instantaneous value of each oscillation component collected in each acquisition period, the dynamic mathematical model of each subsystem of each direct drive wind turbine generator in each acquisition period is established, the subsystems include current loop d axis subsystem, current loop q axis subsystem, grid-connected line d axis subsystem, grid-connected line q axis subsystem, DC voltage outer loop subsystem and phase-locked loop subsystem;

according to the dynamic mathematical model of each subsystem of each direct drive wind turbine generator in each acquisition period, the dynamic coupling energy derivative of each subsystem of each direct drive wind turbine generator is obtained, and the dynamic coupling energy derivative of each generator in each acquisition period is obtained, the corresponding value is used as the energy flow of the dynamic coupling energy transfer path of each generator in each acquisition period;

the energy flow of the dynamic coupling energy transfer path of each generator in each acquisition period is divided to obtain the energy flow of the generator internal coupling path, the generator-generator coupling path and the generator-grid coupling path, then the energy flow of the generator internal coupling path, the generator-generator coupling path and the generator-grid coupling path is divided respectively to obtain the energy flow of each coupling energy transfer path of the direct drive wind farm in each acquisition period.

Further, the key energy transfer paths of direct drive wind farms are tracked by:

based on the set time interval, the energy flow of the last acquisition period of each coupling energy transfer path of the DCD wind farm in this time interval is subtracted from the energy flow of the first acquisition period, and the energy flow variation of each coupling energy transfer path of the direct drive wind farm in this time interval is obtained;

based on the energy flow variation of each coupling energy transfer path of a direct drive wind farm in the set time interval, the coupling energy transfer paths with the largest energy flow variation in the energy flow of the generator internal coupling path, the generator-generator coupling path and the generator-grid coupling path are obtained respectively, and the obtained coupling energy transfer paths are taken as the key energy transfer paths of the direct drive wind farm in the time interval.

Further, the energy flows of each coupling energy transfer path obtained by dividing the generator internal coupling path are as follows:

$$\{ \begin{matrix}{V}_{hi 1} = {i}_{drefi} {u}_{kdi}^{c} cos {Δθ}_{i} \\ {V}_{hi 2} = - {i}_{drefi} {u}_{kqi}^{c} sin {Δθ}_{i} \\ {V}_{hi 3} = - ( {L}_{xi} + 2 {L}_{T} ) ( \frac{{di}_{fdi}^{c} cos {Δθ}_{i}}{d t} {i}_{fdi}^{c} cos {Δθ}_{i} + \frac{{di}_{fdi}^{c} sin {Δθ}_{i}}{d t} {i}_{fdi}^{c} sin {Δθ}_{i} ) + \\ [ {R}_{xi} {i}_{fdi}^{c} sin {Δθ}_{i} + {ω}_{0} ( {L}_{xi} + {L}_{T} ) {i}_{fdi}^{c} cos {Δθ}_{i} + ( {L}_{xi} + {L}_{T} ) \frac{{di}_{fdi}^{c} sin {Δθ}_{i}}{d t} ] {X}_{θ i} \\ {V}_{hi 4} = - ( {L}_{xi} + 2 {L}_{T} ) ( \frac{{di}_{fqi}^{c} cos {Δθ}_{i}}{d t} {i}_{fqi}^{c} cos {Δθ}_{i} + \frac{{di}_{fqi}^{c} sin {Δθ}_{i}}{d t} {i}_{fqi}^{c} sin {Δθ}_{i} ) + \\ [ {R}_{xi} {i}_{fqi}^{c} cos {Δθ}_{i} - {ω}_{0} ( {L}_{xi} + {L}_{T} ) {i}_{fqi}^{c} sin {Δθ}_{i} + ( {L}_{xi} + {L}_{T} ) \frac{{di}_{fqi}^{c} cos {Δθ}_{i}}{d t} ] {X}_{θ i} \\ {V}_{hi 5} = - ( {L}_{xi} + 2 {L}_{T} ) ( \begin{matrix}- \frac{{di}_{fdi}^{c} cos {Δθ}_{i}}{d t} {i}_{fqi}^{c} sin {Δθ}_{i} - \frac{{di}_{fqi}^{c} sin {Δθ}_{i}}{d t} {i}_{fdi}^{c} cos {Δθ}_{i} \\ + \frac{{di}_{fqi}^{c} cos {Δθ}_{i}}{d t} {i}_{fdi}^{c} sin {Δθ}_{i} + \frac{{di}_{fdi}^{c} sin {Δθ}_{i}}{d t} {i}_{fqi}^{c} cos {Δθ}_{i}\end{matrix} )\end{matrix}$$

where Vₕᵢ₁ represents the energy flow of energy transfer path of the DC voltage outer loop, current loop d axis, and PLL of the i-th wind turbine generator; Vₕᵢ₂ represents the energy flow of energy transfer path of DC voltage outer loop, current loop q axis, and PLL of the i-th wind turbine generator; Vₕᵢ₃ represents the energy flow of energy transfer path of current loop d axis and PLL of the i-th wind turbine generator; Vₕᵢ₄ represents the energy flow of the energy transfer path of current loop q axis of the i-th wind turbine generator, and the phase locked loop of the i-th wind turbine generator; and Vₕᵢ₅ represents the energy flow of energy transfer path of the current loop d axis and q axis of the i-th wind turbine generator and the phase locked loop of the i-th wind turbine generator; i_{drefi} is the d-axis current reference value of the current inner loop of the i-th wind turbine generator, U_{kdi}^{c} and U_{kqi}^{c} are respectively the d and q axis components of the state variable of current inner loop of the i-th wind turbine generator under the d-q coordinate system of the control system, Δθᵢ is the dynamic angle of the phase locked loop of the i-th wind turbine generator, Rₓᵢ and Lₓᵢ are respectively the resistance and inductance of the grid-connected line of the i-th wind turbine generator, i_{fdi}^{c} and i_{fqi} ^{c} are the d and q axis components of the output current of the i-th wind turbine generator under the d-q coordinate system of the control system, L_{T} is the inductance of the transformer at the grid-connected bus bar outlet, ω₀ is the grid synchronous angular frequency, and X_{θi} is the state variable of phase locked loop of the i-th wind turbine generator.

Further, the energy flows of each coupling energy transfer path obtained by dividing the generator-generator coupling path are as follows:

$$\{ \begin{matrix}{V}_{ij 1} = {ω}_{0} {L}_{T} {i}_{fdj}^{c} cos {Δθ}_{j} {X}_{θ i} + {L}_{T} \frac{{di}_{fdj}^{c} sin {Δθ}_{j}}{d t} {X}_{θ i} \\ {V}_{ij 2} = - {ω}_{0} {L}_{T} {i}_{fqj}^{c} sin {Δθ}_{j} + {L}_{T} \frac{{di}_{fqj}^{c} cos {Δθ}_{j}}{d t} {X}_{θ i} \\ {V}_{ij 3} = {ω}_{0} {L}_{T} {i}_{fdi}^{c} cos {Δθ}_{i} {X}_{θ j} + {L}_{T} \frac{{di}_{fdi}^{c} sin {Δθ}_{i}}{d t} {X}_{θ j} \\ {V}_{ij 4} = {ω}_{0} {L}_{T} {i}_{fqi}^{c} sin {Δθ}_{i} {X}_{θ j} + {L}_{T} \frac{{di}_{fqi}^{c} cos {Δθ}_{i}}{d t} {X}_{θ j} \\ \begin{matrix}{V}_{ij 5} = - 2 {L}_{T} ( \frac{{di}_{fdj}^{c} cos {Δθ}_{j}}{d t} {i}_{fdi}^{c} cos {Δθ}_{i} + \frac{{di}_{fdj}^{c} sin {Δθ}_{j}}{d t} {i}_{fdi}^{c} sin {Δθ}_{i} + \\ \frac{{di}_{fdi}^{c} cos {Δθ}_{i}}{d t} {i}_{fdj}^{c} cos {Δθ}_{j} + \frac{{di}_{fdi}^{c} sin {Δθ}_{i}}{d t} {i}_{fdj}^{c} sin {Δθ}_{j} )\end{matrix} \\ \begin{matrix}{V}_{ij 6} = - 2 {L}_{T} ( - \frac{{di}_{fqj}^{c} sin {Δθ}_{j}}{d t} {i}_{fdi}^{c} cos {Δθ}_{i} + \frac{{di}_{fqj}^{c} cos {Δθ}_{j}}{d t} {i}_{fdi}^{c} sin {Δθ}_{i} - \\ \frac{{di}_{fdi}^{c} cos {Δθ}_{i}}{d t} {i}_{fqj}^{c} sin {Δθ}_{j} + \frac{{di}_{fdi}^{c} sin {Δθ}_{i}}{d t} {i}_{fqj}^{c} cos {Δθ}_{j} )\end{matrix} \\ \begin{matrix}{V}_{ij 7} = - 2 {L}_{T} ( - \frac{{di}_{fdj}^{c} cos {Δθ}_{j}}{d t} {i}_{fqi}^{c} sin {Δθ}_{i} + \frac{{di}_{fdj}^{c} sin {Δθ}_{j}}{d t} {i}_{fqi}^{c} cos {Δθ}_{i} - \\ \frac{{di}_{fqi}^{c} sin {Δθ}_{i}}{d t} {i}_{fdj}^{c} cos {Δθ}_{j} + \frac{{di}_{fqi}^{c} cos {Δθ}_{i}}{d t} {i}_{fdj}^{c} sin {Δθ}_{j} )\end{matrix} \\ \begin{matrix}{V}_{ij 8} = - 2 {L}_{T} ( \frac{{di}_{fqj}^{c} sin {Δθ}_{j}}{d t} {i}_{fqi}^{c} sin {Δθ}_{i} + \frac{{di}_{fqj}^{c} cos {Δθ}_{j}}{d t} {i}_{fqi}^{c} cos {Δθ}_{i} + \\ \frac{{di}_{fqi}^{c} sin {Δθ}_{i}}{d t} {i}_{fqj}^{c} sin {Δθ}_{j} + \frac{{di}_{fqi}^{c} cos {Δθ}_{i}}{d t} {i}_{fqj}^{c} cos {Δθ}_{j} )\end{matrix}\end{matrix}$$

where Vᵢⱼ₁ represents energy flow of the energy transfer path of phase locked loop of the i-th wind turbine generator, the current loop d axis of the i-th wind turbine generator, and the phase locked loop of the j-th wind turbine generator; Vᵢⱼ₂ represents the energy flow of the energy transfer path of phase locked loop of the i-th wind turbine generator, the current loop q axis of the j-th wind turbine generator, and the phase locked loop of the j-th wind turbine generator; Vᵢⱼ₃ represents the energy flow of the energy transfer path of the current loop d axis of the i-th wind turbine generator, the phase locked loop of the i-th wind turbine generator, and the phase locked loop of the j-th wind turbine generator; Vᵢⱼ₄ represents the energy flow of the energy transfer path of the current loop q axis of the i-th wind turbine generator, the phase locked loop of the i-th wind turbine generator, and the phase locked loop of the j-th wind turbine generator; Vᵢⱼ₅ represents the energy flow of the energy transfer path of the current loop d axis of the i-th wind turbine generator, the phase locked loop of the i-th wind turbine generator, the current loop d axis of the j-th wind turbine generator, and the phase locked loop of the j-th wind turbine generator; Vᵢⱼ₆ represents the energy flow of the energy transfer path of the current loop d axis of the i-th wind turbine generator, the phase locked loop of the i-th wind turbine generator, the current loop q axis of the j-th wind turbine generator, and phase locked loop of the j-th wind turbine generator; Vᵢⱼ₇ represents the energy flow of the energy transfer path of the current loop q axis of the i-th wind turbine generator, the phase locked loop of the i-th wind turbine generator, the current loop d axis of the j-th wind turbine generator, and phase locked loop of the j-th wind turbine generator; Vᵢⱼ₈ represents the energy flow of the energy transfer path of the current loop q axis of the i-th wind turbine generator, the phase locked loop of the i-th wind turbine generator, the current loop q axis of the j-th wind turbine generator, and the phase locked loop of the j-th wind turbine generator; Δθⱼ is the dynamic angle of the phase locked loop of the j-th wind turbine generator; i_{fdj}^{c} and i_{fqj} ^{c} are respectively the d and q axis components of the output current of the j-th wind turbine generator under the d-q coordinate system of the control system; X_{θj} is state variable of the phase locked loop of the j-th wind turbine generator.

Further, the energy flows of each coupling energy transfer path obtained by dividing the generator-grid coupling paths are as follows:

$$\{ \begin{matrix}{V}_{gi 1} = - 2 {u}_{md} {i}_{fdi}^{c} cos {Δθ}_{i} \\ {V}_{g i 2} = - 2 {u}_{m q} {i}_{fdi}^{c} sin {Δθ}_{i} \\ {V}_{g i 3} = 2 {u}_{md} {i}_{fqi}^{c} sin {Δθ}_{i} \\ {V}_{g i 4} = - 2 {u}_{m q} {i}_{fqi}^{c} cos {Δθ}_{i} \\ {V}_{gi 5} = {u}_{m q} {X}_{θ i}\end{matrix}$$

where V_{gi1} represents the energy flow of the energy transfer path of the current loop d axis of the i-th wind turbine generator, the phase locked loop of the i-th wind turbine generator, and the d axis of the grid; V_{gi2} represents the energy flow of the energy transfer path of the current loop d axis of the i-th wind turbine generator, the phase locked loop of the i-th wind turbine generator, and the q axis of the grid; V_{gi3} represents the energy flow of the energy transfer path of the current loop q axis of the i-th wind turbine generator, the phase locked loop of the i-th wind turbine generator, and the d axis of the power grid; V_{gi4}represents the energy flow of the energy transfer path of the current loop q axis of the i-th wind turbine generator, the phase locked loop of the i-th wind turbine generator, and the q axis of the grid; V_{gi5} represents the energy flow of the energy transfer path of the phase locked loop of the i-th wind turbine generator and the q axis of the grid; u_{md} and u_{mq}represent the d and q axis components of the fault point voltage respectively.

Further, the dominant oscillation mode period is

$$\frac{2 π}{{ω}_{c}} ;$$

Where, ω_{c} represents the oscillation frequency of the dominant oscillation mode of the system.

Further, the instantaneous value of each oscillation component of the direct drive wind turbine generator is expressed as:

$$\{ \begin{matrix}{i}_{fdi}^{c} = {A}_{d i} {e}^{α t} sin ( {ω}_{c} t + {φ}_{d i} ) \\ {i}_{fqi}^{c} = {A}_{q i} {e}^{α t} sin ( {ω}_{c} t + {φ}_{q i} )\end{matrix} {i}_{drefi} = {A}_{drefi} {e}^{α t} sin ( {ω}_{c} t + {φ}_{drefi} ) {u}_{kdi}^{c} = {A}_{ukdi} {e}^{α t} sin ( {ω}_{c} t + {φ}_{ukdi} ) {Δθ}_{i} = {A}_{θ i} {e}^{α t} sin ( {ω}_{c} t + {φ}_{θ i} ) {X}_{θ i} = {A}_{x θ i} {e}^{α t} sin ( {ω}_{c} t + {φ}_{x θ i} ) \{ \begin{matrix}{u}_{m d} = {A}_{m d} {e}^{α t} sin ( {ω}_{c} t + {φ}_{m d} ) \\ {u}_{m q} = {A}_{m q} {e}^{α t} sin ( {ω}_{c} t + {φ}_{m q} )\end{matrix}$$

where, A_{di} and A_{qi} respectively represent the amplitude of d and q axis components of the output current of the i-th wind turbine generator, α represents the damping coefficient of the system, ω_{c} represents the oscillation frequency under the d-q coordinate system of the control system, φ_{di} and φ_{qi} represent the phases of d and q components of the output current of the i-th wind turbine generator, and A_{drefi} represents the amplitude of the d-axis current reference value of the current inner loop of the i-th wind turbine generator, φ_{drefi} is the phase of the d-axis current reference value of the current inner loop of the i-th wind turbine generator, A_{ukdi} is the amplitude of the d-axis component of state variable of the current inner loop of the i-th wind turbine generator, φ_{ukdi} is the phase of the d-axis component of state variable of the current inner loop of the i-th wind turbine generator, A_{θi} is the amplitude of the dynamic angle of the phase locked loop of the i-th wind turbine generator, φ_{θi} is the phase of the dynamic angle of the phase locked loop of the i-th wind turbine generator, A_{xθi} is the amplitude of state variable of the PLL of the i-th wind turbine generator, φ_{xθi} is the phase of state variable of the PLL of the i-th wind turbine generator, A_{md} and A_{mq} are the amplitudes of the d and q axis components of the fault point voltage respectively, and φ_{md} and φ_{mq} are the phases of the d and q axis components of the fault point voltage respectively.

In a further aspect, the application provides a system for tracking oscillation path of a direct drive wind farm, includes:

the data acquisition module, which is used to collect the port current, the current and state variable of the current inner loop, the dynamic angle and state component of the phase-locked loop and the phase and amplitude of the fault point voltage of each wind turbine generator when a direct drive wind farm fails, and then to obtain the corresponding instantaneous value of each oscillation component of the direct drive wind turbine generator;

the coupling energy transfer path acquisition module, which is used to obtain the energy flow of the coupling energy transfer path of the direct drive wind farm in each acquisition period based on the instantaneous value of each oscillation component collected in each acquisition period;

the key energy transfer path tracking module, which is used to track the key energy transfer path of the direct drive wind farm according to the energy flow of the coupling energy transfer path of the direct drive wind farm in each acquisition period, so as to realize the stability control of the direct drive wind farm.

Further, the coupling energy transfer path acquisition module obtains the energy flow of the coupling energy transfer path between subsystems of the direct drive wind farm in each acquisition period by:

based on the instantaneous value of each oscillation component collected in each acquisition period, the dynamic mathematical model of each subsystem of each direct drive wind turbine generator in each acquisition period is established, the subsystems include current loop d, q axis subsystems, grid-connected line d, q axis subsystems, DC voltage outer loop subsystem and phase-locked loop subsystem;

according to the dynamic mathematical model of each subsystem of each direct drive wind turbine generator in each acquisition period, the dynamic coupling energy derivative of each subsystem of each direct drive wind turbine generator is obtained, and the dynamic coupling energy derivative of each generator in each acquisition period is obtained, the corresponding value is used as the energy flow of the dynamic coupling energy transfer path of each generator in each acquisition period;

the energy flow of the dynamic coupling energy transfer path of each generator in each acquisition period is divided to obtain the energy flow of the generator internal coupling path, the generator-generator coupling path and the generator-grid coupling path. Then the energy flow of the generator internal coupling path, the generator-generator coupling path and the generator-grid coupling path is divided respectively to obtain the energy flow of each coupling energy transfer path of the direct drive wind farm in each acquisition period.

Compared with the prior art, the application has the following beneficial effects:

The application provides a method and system for tracking the oscillation path of a direct drive wind farm. When the direct drive wind farm fails, the data is collected by taking the dominant oscillation mode period as the acquisition period to obtain the corresponding instantaneous value of each oscillation component, and the energy flow of the coupling energy transfer path between the subsystems of the direct drive wind farm with each acquisition period is obtained. Then, the key energy transfer path of the direct drive wind farm in each acquisition period is tracked to achieve accurate and effective tracking of the key energy transfer path of the grid-connected system of the direct drive wind farm, and guiding suggestions are given for the stable and safe operation of the power system. And by dividing the whole wind turbine generator into multiple subsystems, the key control links that affect the stability level of the system are selected out. The coupling energy transfer paths obtained by dynamic coupling energy derivatives reduce the calculation amount, improve the calculation accuracy and ensure the reliable operation of the system.

In this application, the above technical schemes can also be combined with each other to realize more optimal combination schemes. Other characteristics and advantages of the present application will be described in a subsequent specification, and some of the advantages may become apparent from the specification or may be understood through the implementation of the present application. The purpose and other advantages of the application may be realized and obtained through the contents specifically indicated in the specification and the appended drawings.

### BRIEF DESCRIPTION OF THE DRAWINGS

The appended drawings are used only for the purpose of showing specific embodiments and are not considered to be a limitation of the present application. Throughout the appended drawings, the same reference symbols represent the same components.

FIG. 1 is a flow diagram of the direct drive wind farm oscillation path tracking method provided in example 1 of the application;

FIG. 2 is a structural diagram of the grid-connected system of the direct drive wind farm provided in example 1 of the application;

FIG. 3 is a coupling energy transfer path diagram of each subsystem in the direct drive wind turbine generator provided in example 1 of the application;

FIG. 4 is a coupling energy transfer path diagram of each subsystem between the direct drive wind turbine generators provided in example 1 of the application;

FIG. 5 is a coupling energy transfer path diagram between a direct drive wind turbine generator and a power grid subsystem for example 1 of the application;

FIG. 6A is a graph of the energy flow Vₕᵢ₁ of the generator internal coupling energy transfer path for example 3 of the application;

FIG. 6B is a graph of the energy flow Vₕᵢ₂ of the generator internal coupling energy transfer path provided for example 3 of the application;

FIG. 6C is a diagram of the energy flow Vₕᵢ₃ of the generator internal coupling energy transfer path provided for example 3 of the application;

FIG. 6D is a diagram of the energy flow Vₕᵢ₄ of the generator internal coupling energy transfer path provided for example 3 of the application;

FIG. 6E is a graph of the energy flow Vₕᵢ₅ of the generator internal coupling energy transfer path for example 3 of the application;

FIG. 7A is a graph of the energy flow Vᵢⱼ₁ of the generator-generator coupling energy transfer path provided for example 3 of the application;

FIG. 7B is a graph of the energy flow Vᵢⱼ₂ of the generator-generator coupling energy transfer path provided for example 3 of the application;

FIG. 7C is a graph of the energy flow Vᵢⱼ₃ of the generator-generator coupling energy transfer path provided for example 3 of the application;

FIG. 7D is a graph of the energy flow Vᵢⱼ₄ of the generator-generator coupling energy transfer path provided for example 3 of the application;

FIG. 7E is a graph of the energy flow Vᵢⱼ₅ of the generator-generator coupling energy transfer path provided for example 3 of the application;

FIG. 7F is a graph of the energy flow Vᵢⱼ₆ of the generator-generator coupling energy transfer path provided for example 3 of the application;

FIG. 7G is a graph of the energy flow Vᵢⱼ₇ in the generator-generator coupling energy transfer path provided for example 3 of the application;

FIG. 7H is a graph of the energy flow Vᵢⱼ₈ in the generator-generator coupling energy transfer path provided for example 3 of the application;

FIG. 8A is a graph of the energy flow V_{gi1} of the generator-grid coupling energy transfer path for example 3 of the application;

FIG. 8B is a graph of the energy flow V_{gi2} of the generator-grid coupling energy transfer path for example 3 of the application;

FIG. 8C is a graph of the energy flow V_{gi3} of the generator-grid coupling energy transfer path for example 3 of the application;

FIG. 8D is a graph of the energy flow V_{gi4} of the generator-grid coupling energy transfer path for example 3 of the application;

FIG. 8E is a graph of the energy flow V_{gi5} of the generator-grid coupling energy transfer path for example 3 of the application.

### DETAILED DESCRIPTION

The proposed method is described in detail below in conjunction with the diagrams in the appendix. It should be emphasized that the following description is only exemplary and is not intended to limit the scope of this invention and its application.

### Example 1

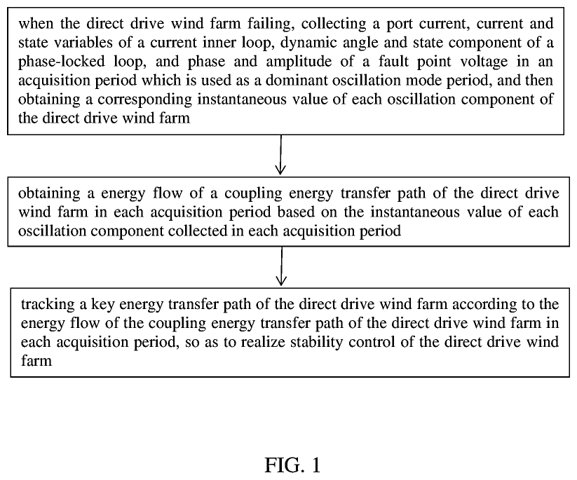

A specific embodiment of the application discloses a method for tracking the oscillation path of a direct drive wind farm, as shown in FIG. 1, including the following steps:

S1: When a direct drive wind farm fails, the dominant oscillation mode period is taken as the acquisition period to collect the port current, current and state variables in the current inner loop, dynamic angle and state component of phase locked loop, and the phase and amplitude of the fault point voltage of each wind turbine generator, and then the corresponding instantaneous value of each oscillation component of the direct drive wind turbine generator is obtained.

When implemented, the instantaneous value of each oscillation component of the direct drive wind turbine generator is expressed as:

$$\{ \begin{matrix}{i}_{fdi}^{c} = {A}_{d i} {e}^{α t} sin ( {ω}_{c} t + {φ}_{d i} ) \\ {i}_{fqi}^{c} = {A}_{q i} {e}^{α t} sin ( {ω}_{c} t + {φ}_{q i} )\end{matrix} {i}_{drefi} = {A}_{drefi} {e}^{α t} sin ( {ω}_{c} t + {φ}_{drefi} ) {u}_{kdi}^{c} = {A}_{ukdi} {e}^{α t} sin ( {ω}_{c} t + {φ}_{ukdi} ) Δ {θ}_{i} = {A}_{θ i} {e}^{α t} sin ( {ω}_{c} t + {φ}_{θ i} ) {X}_{θ i} = {A}_{x θ i} {e}^{α t} sin ( {ω}_{c} t + {φ}_{x θ i} ) \\ \{ \begin{matrix}{u}_{m d} = {A}_{m d} {e}^{α t} sin ( {ω}_{c} t + {φ}_{m d} ) \\ {u}_{m q} = {A}_{m q} {e}^{α t} sin ( {ω}_{c} t + {φ}_{m q} )\end{matrix}$$

where, i_{fdi}^{c} and i_{fqi}^{c} are respectively the d and q axis components of the output current of the i-th wind turbine generator under the d-q coordinate system of the control system; A_{di} and A_{qi} are respectively the amplitudes of the d and q axis components of the output current of the i-th wind turbine generator; α is the system damping coefficient; ω_{c} is the oscillation frequency under the d-q coordinate system of the control system; φ_{di} and φ_{qi} are respectively the phases of the d and q components of the output current of the i-th wind turbine generator; i_{drefi} is the d-axis current reference value of the current inner loop of the i-th wind turbine generator, A_{drefi} is the amplitude of the d-axis current reference value of the current inner loop of the i-th wind turbine generator, φ_{drefi} is the phase of the d axis current reference value of the current inner loop of the i-th wind turbine generator, and u_{kdi}^{c} is the d axis component of the state variable of the current inner loop of the i-th wind turbine generator under the d-q coordinate system of the control system; A_{ukdi} is the amplitude of the d-axis component of the state variable of the current internal loop of the i-th wind turbine generator, φ_{ukdi} is the phase of the d-axis component of the state variable of the current internal loop of the i-th wind turbine generator, Δθᵢ is the dynamic angle of the phase locked loop of the i-th wind turbine generator, A_{θi} is the amplitude of the dynamic angle of the phase locked loop of the i-th wind turbine generator, φ_{θi} is the phase of the dynamic angle of the phase locked loop of the i-th wind turbine generator, and X_{θi} is the state variable of the phase locked loop of the i-th wind turbine generator. A_{xθi} is the amplitude of the state variable of the phase locked loop of the i-th wind turbine generator, φ_{xθi} is the phase of the state variable of the phase locked loop of the i-th wind turbine generator, u_{md} and u_{mq} are respectively the d and q axis components of the fault point voltage, A_{md} and A_{mq} are respectively the amplitudes of the d and q axis components of the fault point voltage, φ_{md} and φ_{mq} are respectively the phases of the d and q axis components of the fault point voltage. It should be noted that the parameter superscript “c” represents the variable under the d-q coordinate system of the control system, the absence of superscript “c” represents the variable under the d-q coordinate system of the power grid, and the subscript “i” represents the i-th wind turbine generator.

Specifically, data are collected by PMU devices installed on the ports of each wind turbine generator in a direct drive wind farm.

More specifically, the dominant oscillation mode period is

$$\frac{2 π}{{ω}_{c}} ;$$

where, ω_{c}

represents the oscillation frequency of the dominant oscillation mode of the system.

S2: Based on the instantaneous value of each oscillation component collected in each acquisition period, the energy flow of the coupling energy transfer path of the direct drive wind farm in each acquisition period is obtained.

When implemented, the energy flow of the coupling energy transfer path between subsystems of the direct drive wind farm in each acquisition period is obtained by the following ways:

S21: Based on the instantaneous value of each oscillation component collected in each acquisition period, the dynamic mathematical model of each subsystem of each direct drive wind turbine generator in the direct drive wind farm in each acquisition period is established; the subsystems include current loop d and q axis subsystems, grid-connected line d and q axis subsystems, DC voltage outer loop subsystem and phase-locked loop subsystem.

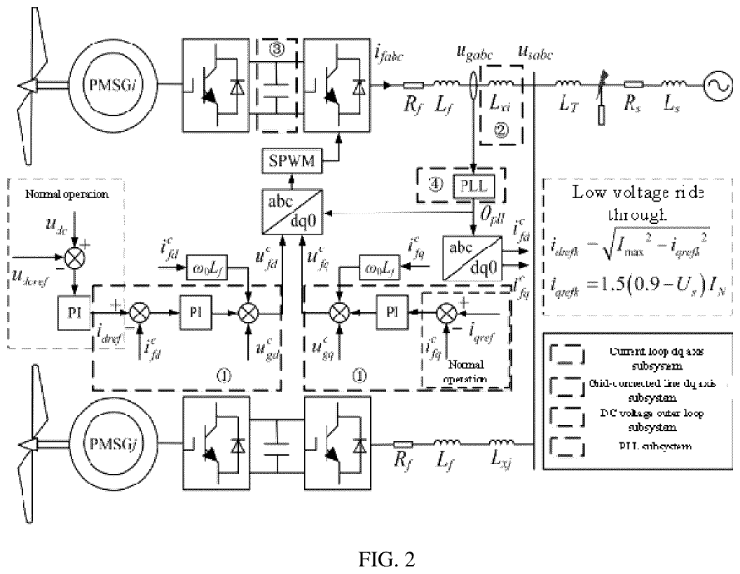

Specifically, as shown in FIG. 2, each direct drive wind turbine is divided into 6 subsystems according to each control link, which are current loop d, q axes subsystems, grid-connected line d, q axes subsystems, DC voltage outer loop subsystem and phase-locked loop subsystem. The dynamic mathematical models of each subsystem are as follows:

The dynamic mathematical models of the the current loop d and q axis subsystems are respectively:

$$\{ \begin{matrix}\frac{1}{{k}_{Ii}} \frac{d {u}_{kdi}}{d t} = - {i}_{fdi} + {i}_{drefi} \\ {L}_{f} \frac{d {i}_{fdi}}{d t} = - ( {k}_{P i} + {R}_{f} ) {i}_{fdi} + {u}_{kdi} + {k}_{P i} {i}_{drefi} + {ω}_{0} {L}_{f} {i}_{fqi} - {u}_{g d i}\end{matrix} \{ \begin{matrix}\frac{1}{{k}_{Ii}} \frac{d {u}_{kqi}}{d t} = - {i}_{fqi} + {i}_{qrefi} \\ {L}_{f} \frac{d {i}_{fqi}}{d t} = - ( {k}_{P i} + {R}_{f} ) {i}_{fqi} + {u}_{kqi} + {k}_{P i} {i}_{qrefi} - {ω}_{0} {L}_{f} {i}_{fdi} - {u}_{gqi}\end{matrix}$$

where, k_{Pi} and k_{Ii} are the proportion and integral coefficient of the inner current loop of the i-th wind turbine generator; R_{f} and L_{f} are the resistance and inductance of the filtering link respectively; i_{fdi} and i_{fqi} are the d and q axis components of the output current of the i-th wind turbine generator respectively; u_{kdi} and u_{kqi} are the d and q axis components of the state variable of the inner current loop of the i-th wind turbine generator respectively. i_{drefi} and i_{qrefi} are respectively the d and q axis current reference values of the current inner loop of the i-th wind turbine generator, ω₀ is the synchronous angular frequency of the grid, and u_{gdi} and u_{gqi} are respectively the d and q axis components of the PLL sampling point voltage of the i-th wind turbine generator. The sampling point is a bus bar located at the wind turbine port.

The dynamic mathematical models of grid-connected line d and q axis subsystems are as follows:

$${L}_{xi} \frac{d {i}_{fdi}}{d t} = - {R}_{xi} {i}_{fdi} + {ω}_{0} {L}_{xi} {i}_{fqi} + {u}_{fdi} - {u}_{s d} \\ {L}_{xi} \frac{d {i}_{fqi}}{d t} = - {R}_{xi} {i}_{fqi} - {ω}_{0} {L}_{xi} {i}_{fdi} + {u}_{fqi} - {u}_{s q}$$

where, Rₓᵢ and Lₓᵢ are respectively the resistance and inductance of the grid-connected line of the i-th wind turbine generator, and u_{sd} and u_{sq} are respectively the d and q axis components of the system PCC point voltage.

The dynamic mathematical model of the DC voltage outer loop subsystem is as follows:

$${C}_{f} {u}_{d c i} \frac{d {u}_{d c i}}{d t} = - ( {u}_{fdi} {i}_{fdi} + {u}_{fqi} {i}_{fqi} ) + {P}_{m}$$

where, C_{f} is the DC capacitance, u_{dci} is the DC capacitance voltage of the i-th wind turbine generator, u_{fdi} and u_{fqi} are the d and q axis components of the terminal voltage of the i-th wind turbine generator respectively, and Pₘ is the mechanical power transmitted by the converter at the side of the generator.

The dynamic mathematical model of the phase-locked loop subsystem is:

$$\{ \begin{matrix}\frac{1}{{k}_{I θ i}} \frac{{dX}_{θ i}}{d t} = {u}_{gqi} \\ \frac{d {θ}_{pll i}}{d t} = {X}_{θ i} + {ω}_{0} + {k}_{P θ i} {u}_{gqi}\end{matrix}$$

where, k_{Pθi} and k_{Iθi} are the proportion and integral coefficient of the phase locked loop of the i-th wind turbine generator respectively, and θₚₗₗᵢ is the output phase locked angle of the i-th wind turbine generator.

S22: According to the dynamic mathematical model of each subsystem of each direct drive wind turbine generator in the direct drive wind farm in each acquisition period, the dynamic coupling energy derivative of each subsystem of each direct drive wind turbine generator is obtained, and the dynamic coupling energy derivative of each generator in each acquisition period is obtained, and the corresponding value is used as the energy flow of the dynamic coupling energy transfer path of each generator in each acquisition period.

Specifically, the dynamic coupling energy derivatives of each subsystem of each direct drive wind turbine generator are:

The dynamic coupling energy derivatives W^{&}_{zfdi} and W^{&}_{zfqi} of the current loop d and q axis subsystems are respectively expressed as:

$${W}_{zfdi}^{\&} = {i}_{drefi} {u}_{kdi} + ( {k}_{Pi} {i}_{drefi} + {ω}_{0} {L}_{f} {i}_{fqi} - {u}_{gdi} ) {i}_{fdi} \\ {W}_{zfqi}^{\&} = {i}_{qrefi} {u}_{kqi} + ( {k}_{Pi} {i}_{qrefi} + {ω}_{0} {L}_{f} {i}_{fdi} - {u}_{gqi} ) {i}_{fqi}$$

The dynamic coupling energy derivatives \dot{W}_{zldi} and \dot{W}_{zlqi} of the grid-connected line d and q axis subsystems are respectively expressed as:

$${\dot{W}}_{z l d i} = ( {u}_{g d i} - {u}_{s d} + {ω}_{0} {L}_{x i} {i}_{fqi} ) {i}_{fdi} \\ {\dot{W}}_{z l q i} = ( {u}_{gqi} - {u}_{s q} - {ω}_{0} {L}_{x i} {i}_{fdi} ) {i}_{fqi}$$

The dynamic coupling energy derivative \dot{W}_{zdci} of the DC voltage outer loop subsystem is expressed as:

$${W}_{z d c i} = - {k}_{P i} {i}_{drefi} {i}_{fdi} + {k}_{P i} {i}_{fdi} {i}_{fdi} - {i}_{fdi} {u}_{kdi} - {u}_{g d i} {i}_{fdi} - {k}_{P i} {i}_{qrefi} {i}_{fqi} + {k}_{P i} {i}_{fqi} {i}_{fqi} - {i}_{fqi} {u}_{k q i} - {u}_{g q i} {i}_{fqi} + {P}_{m}$$

The dynamic coupling energy derivative W^{&}_{zθi} of the phase-locked loop subsystem is expressed as:

W^{&}_{zθi}=u_{gqi}X_{θi}

Based on this, the dynamic coupling energy derivative W^{&}_{zi} of the i-th wind turbine generator is obtained, that is, the energy flow of the dynamic coupling energy transfer path of the i-th wind turbine generator, expressed as:

$${W}_{z i}^{\&} = {W}_{zfdi}^{\&} + {W}_{zfqi}^{\&} + {W}_{z l d i}^{\&} + {W}_{z l q i}^{\&} + {W}_{z d c i}^{\&} + {W}_{z θ i}^{\&} = ( {i}_{drefi} - {i}_{fdi} ) {u}_{k d i} + ( {i}_{qrefi} - {i}_{fqi} ) {u}_{k q i} + {k}_{P i} ( {i}_{fdi}^{2} + {i}_{fqi}^{2} ) - ( {u}_{g d i} + {u}_{s d} ) {i}_{fdi} - ( {u}_{g q i} + {u}_{s q} ) {i}_{fqi} + {u}_{g q i} {X}_{θ i} + {P}_{m}$$

therein,

$${u}_{gdi} = {R}_{xi} {i}_{fdi} + {L}_{xi} \frac{d {i}_{fdi}}{d t} - {ω}_{0} {L}_{xi} {i}_{fqi} + {L}_{T} \frac{d ( {i}_{fdi} + {i}_{fdj} )}{d t} - {ω}_{0} {L}_{T} ( {i}_{fqi} + {i}_{fqj} ) + {u}_{md}$$

$${u}_{gqi} = {R}_{xi} {i}_{fqi} + {L}_{xi} \frac{d {i}_{fqi}}{d t} + {ω}_{0} {L}_{xi} {i}_{fdi} + {L}_{T} \frac{d ( {i}_{fqi} + {i}_{fqj} )}{d t} + {ω}_{0} {L}_{T} ( {i}_{fdi} + {i}_{f d j} ) + {u}_{m q}$$

Where, Lᵣ represents the inductance of the transformer at the grid-connected bus bar outlet.

It should be noted that the object of the transfer path is determined according to the control link corresponding to the variable contained in the derivative expression, so that the transfer path is represented by the derivative expression, and the specific value of the derivative obtained is the energy flow of the transfer path.

It should be noted that the dynamic coupling energy derivative basis of each subsystem is obtained based on the following analysis:

The dynamic mathematical model of the 6 subsystems can be uniformly expressed as follows:

$$\{ \begin{matrix}A \frac{d x}{d t} = - C y + {H}_{x} \\ B \frac{d y}{d t} = - D y + E x + {H}_{y}\end{matrix}$$

In the formula, A, B, C, D, E, H, and H_{y} represent coefficients respectively, and x and y are variables respectively.

The first integration method was used to construct the energy function, and the two formulas above were cross-multiplied and integrated to obtain the dynamic energy model corresponding to each subsystem as follows:

$$\frac{1}{2} A E {x}^{2} + \frac{1}{2} B C {y}^{2} + C D \int {y}^{2} d t - C \int {H}_{y} y d t - E \int {H}_{x} x dt = Const$$

where Const represents the integral constant, AEx²/2 and BCy²/2 correspond to the dynamic storage energy injected into the corresponding control links of x and y in the subsystem after the fault, denoted as W_{\dot{s}}, −CD∫y²dt corresponds to the dynamic dissipated energy injected into the corresponding control link of y in the subsystem after the fault, and is denoted as W_{d}. C∫H_{y}ydt and E∫Hₓxdt correspond to the dynamic coupling energy generated between the corresponding control links of x and y and other control links injected into the subsystem after the fault, and are denoted as W_{z}. It is known that they satisfy Wₛ^{&}=W_{d}^{&}+W_{z}^{&}.

The response process of wind farm after disturbance is essentially a process of energy storage, dissipation and coupling among all links, which follows the law of energy conservation. According to Lyapunov's second law, the state variables of a disturbed system will deviate from the equilibrium point and obtain a certain dynamic storage energy. If the dynamic storage energy gradually decays to the minimum value over time, the system can gradually recover stability in this state. On the contrary, if the dynamic storage energy of the system continues to increase, the system is unstable. The dynamic dissipative energy is always negative, which is conducive to the stability of the system, and the dynamic coupling energy is the direct reason to determine the stability of the system. When the energy derivative is positive, the stored energy continues to increase, and the system stability decreases, and the larger the value, the worse the system stability. Therefore, the variation of the dynamic coupling energy derivative directly reflects the stability of the system.

The expression of the dynamic coupling energy derivative obtained from the above equation is as follow:

$${W}_{z}^{\&} = {EH}_{x} x + {CH}_{y} y$$

Therefore, the dynamic coupling energy derivative can be obtained according to the dynamic mathematical model of each subsystem of each direct drive wind turbine generator.

S23: The energy flow of the dynamic coupling energy transfer path of each generator in each acquisition period is divided to obtain the energy flow of the generator internal coupling path the generator-generator coupling path and the generator-grid coupling path. Then the energy flow of the generator internal coupling path, the generator-generator coupling path and the generator-grid coupling path is divided respectively to obtain the energy flow of each coupling energy transfer path of the direct drive wind farm in each acquisition period.

Specifically, the generator internal coupling path of each wind turbine generator contains only the relevant variables of the generator. The generator-generator coupling path of each wind turbine generator contains the variables of the wind turbine generator and any other wind turbine generator. The generator-grid coupling path of each wind turbine generator includes the variables of the generator and the power grid.

Therefore, based on the expression of the dynamic coupling energy transfer path W^{&}_{zi} of each generator, the energy flow of the generator internal coupling path, the generator-generator coupling path and the generator-grid coupling path of each turbine generator is obtained, which is expressed as follows:

The energy flow of the generator internal coupling path is:

$${V}_{hi} = {i}_{d r e f} ( {u}_{kdi}^{c} cos {Δθ}_{i} - {u}_{kqi}^{c} sin {Δθ}_{i} ) - {i}_{fdi}^{c} {u}_{kdi}^{c} - {i}_{fqi}^{c} {u}_{kqi}^{c} + ( {k}_{Pi} - {R}_{xi} ) ( {i}_{fdi}^{c 2} + {i}_{fqi}^{c 2} ) - ( {L}_{xi} + 2 {L}_{T} ) ( \begin{matrix}\frac{d ( {i}_{fdi}^{c} cos {Δθ}_{i} - {i}_{fqi}^{c} sin {Δθ}_{i} )}{d t} ( {i}_{fdi}^{c} cos {Δθ}_{i} - {i}_{fqi}^{c} sin {Δθ}_{i} ) + \\ \frac{d ( {i}_{fqi}^{c} cos {Δθ}_{i} + {i}_{fdi}^{c} sin {Δθ}_{i} )}{d t} ( {i}_{fqi}^{c} cos {Δθ}_{i} + {i}_{fdi}^{c} sin {Δθ}_{i} )\end{matrix} ) + [ \begin{matrix}{R}_{xi} ( {i}_{fqi}^{c} cos {Δθ}_{i} + {i}_{fdi}^{c} sin {Δθ}_{i} ) + ( {L}_{xi} + {L}_{T} ) \frac{d ( {i}_{fqi}^{c} cos {Δθ}_{i} + {i}_{fdi}^{c} sin Δ {θ}_{i} )}{dt} + \\ {ω}_{0} ( {L}_{xi} + {L}_{T} ) ( {i}_{fdi}^{c} cos {Δθ}_{i} - {i}_{fqi}^{c} sin Δ {θ}_{i} )\end{matrix} ] {X}_{θ i}$$

where, Vₕᵢ represents the energy flow of the coupling path in the generator.

The energy flow of the generator-generator coupling path is:

$${V}_{ti - j} = - 2 {L}_{T} [ \begin{matrix}( \frac{{di}_{fdj}^{c} cos {Δθ}_{j}}{d t} - \frac{{di}_{fqj}^{c} sin {Δθ}_{j}}{d t} ) ( {i}_{fdi}^{c} cos {Δθ}_{i} - {i}_{fqi}^{c} sin {Δθ}_{i} ) + \\ ( \frac{{di}_{fqj}^{c} cos {Δθ}_{j}}{d t} + \frac{{di}_{fdj}^{c} sin {Δθ}_{j}}{d t} ) ( {i}_{fqi}^{c} cos {Δθ}_{i} + {i}_{fdi}^{c} sin {Δθ}_{i} ) \\ + {ω}_{0} ( {i}_{fdj}^{c} cos {Δθ}_{j} - {i}_{fdj}^{c} sin {Δθ}_{j} ) ( {i}_{fqi}^{c} cos {Δθ}_{i} + {i}_{fdi}^{c} sin {Δθ}_{i} ) \\ - {ω}_{0} ( {i}_{fdj}^{c} cos {Δθ}_{j} + {i}_{fdj}^{c} sin {Δθ}_{j} ) ( {i}_{fdi}^{c} cos {Δθ}_{i} - {i}_{fqi}^{c} sin {Δθ}_{i} )\end{matrix} ] + [ + {L}_{T} \frac{d ( {i}_{fqj}^{c} cos Δ {θ}_{j} + {i}_{f d j}^{c} sin Δ {θ}_{j} )}{d t} + {ω}_{0} L ( {i}_{f d j}^{c} cos Δ {θ}_{j} - {i}_{fqj}^{c} sin Δ {θ}_{j} ) ] {X}_{θ i}$$

where, Vₜᵢ₋ⱼ represents the energy flow of the generator-generator coupling path.

The energy flow of the generator-grid coupling path is:

$${V}_{gi} = - 2 {u}_{md} ( {i}_{fdi}^{c} cos {Δθ}_{i} - {i}_{fqi}^{c} sin {Δθ}_{i} ) - 2 {u}_{m q} ( {i}_{fqi}^{c} cos {Δθ}_{i} + {i}_{fdi}^{c} sin {Δθ}_{i} ) + {u}_{m q} {X}_{θ i}$$

where V_{gi} represents the energy flow of the generator-grid coupling path.

In the same way, the energy flow of the related energy coupling transfer path of the j-th wind turbine generator in the direct drive wind farm can be obtained, i≠j.

Specifically, the energy flow of the generator internal coupling path, the generator-generator coupling path and the generator-grid coupling path is divided, and the energy flow of the coupling energy transfer path of the direct drive wind farm in each acquisition period is as follows:

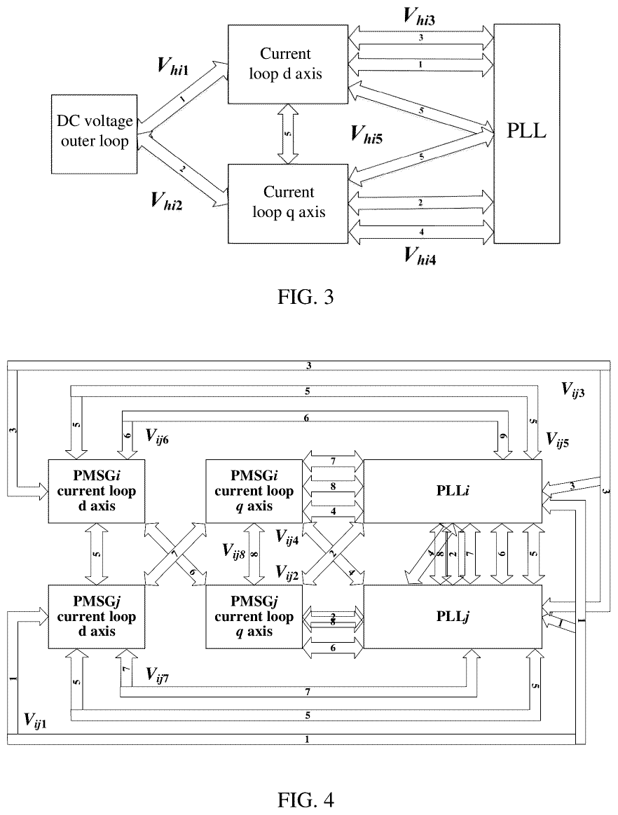

As shown in FIG. 3, the energy flows of each coupling energy transfer path obtained by dividing the generator internal coupling path are as follows:

$$\{ \begin{matrix}{V}_{hi 1} = {i}_{d r e f i} {u}_{kdi}^{c} cos {Δθ}_{i} \\ {V}_{hi 2} = - {i}_{d r e f i} {u}_{kqi}^{c} sin Δ {θ}_{i} \\ \begin{matrix}{V}_{hi 3} = - ( {L}_{xi} + 2 {L}_{T} ) ( \frac{d {i}_{fdi}^{c} cos {Δθ}_{i}}{d t} {i}_{fdi}^{c} cos {Δθ}_{i} + \frac{{di}_{fdi}^{c} sin {Δθ}_{i}}{d t} {i}_{fdi}^{c} sin {Δθ}_{i} ) + \\ [ {R}_{xi} {i}_{fdi}^{c} sin {Δθ}_{i} + {ω}_{0} ( {L}_{xi} + {L}_{T} ) {i}_{fdi}^{c} cos Δ {θ}_{i} + ( {L}_{xi} + {L}_{T} ) \frac{d {i}_{fdi}^{c} sin Δ {θ}_{i}}{d t} ] {X}_{θ i}\end{matrix} \\ \begin{matrix}{V}_{hi 4} = - ( {L}_{xi} + 2 {L}_{T} ) ( \frac{{di}_{fqi}^{c} cos Δ {θ}_{i}}{d t} {i}_{fqi}^{c} cos Δ {θ}_{i} + \frac{{di}_{fqi}^{c} sin Δ {θ}_{i}}{d t} {i}_{fqi}^{c} sin Δ {θ}_{i} ) + \\ [ {R}_{xi} {i}_{fqi}^{c} cos Δ {θ}_{i} - {ω}_{0} ( {L}_{xi} + {L}_{T} ) {i}_{fqi}^{c} sin Δ {θ}_{i} + ( {L}_{xi} + {L}_{T} ) \frac{{di}_{fqi}^{c} cos Δ {θ}_{i}}{d t} ] {X}_{θ i} \\ {V}_{hi 5} = - ( {L}_{xi} + 2 {L}_{T} ) ( \begin{matrix}- \frac{{di}_{fdi}^{c} cos Δ {θ}_{i}}{dt} {i}_{fqi}^{c} sin Δ {θ}_{i} - \frac{{di}_{fqi}^{c} sin {Δθ}_{i}}{dt} {i}_{fdi}^{c} cos Δ {θ}_{i} \\ + \frac{{di}_{fqi}^{c} cos Δ {θ}_{i}}{dt} {i}_{fdi}^{c} sin Δ {θ}_{i} - \frac{{di}_{fdi}^{c} sin {Δθ}_{i}}{dt} {i}_{fqi}^{c} cos Δ {θ}_{i}\end{matrix} )\end{matrix}\end{matrix}$$

where Vₕᵢ₁ represents the energy flow of the energy transfer path of the DC voltage outer loop, current loop d axis, and PLL of the i-th wind turbine generator; Vₕᵢ₂ represents the energy flow of the energy transfer path of the DC voltage outer loop, current loop q axis, and PLL of the i-th wind turbine generator; Vₕᵢ₃ represents the energy flow of the energy transfer path of the current loop d axis and PLL of the i-th wind turbine generator; Vₕᵢ₄ represents the energy flow of the energy transfer path of the current loop q axis of the i-th wind turbine generator and the phase locked loop of the i-th wind turbine generator, and Vₕᵢ₅ represents the energy flow of the energy transfer path of the current loop d axis, q axis of the i-th wind turbine generator, and the phase locked loop of the i-th wind turbine generator.

As shown in FIG. 4, the energy flows of each coupling energy transfer path obtained by dividing the generator-generator coupling paths are as follows:

$$\{ \begin{matrix}{V}_{ij 1} = {ω}_{0} {L}_{T} {i}_{fdj}^{c} cos Δ {θ}_{j} {X}_{θ i} + {L}_{T} \frac{{di}_{fdj}^{c} sin Δ {θ}_{j}}{dt} {X}_{θ i} \\ {V}_{ij 2} = - {ω}_{0} {L}_{T} {i}_{fqj}^{c} sin Δ {θ}_{j} + {L}_{T} \frac{{di}_{fqj}^{c} cos Δ {θ}_{j}}{dt} {X}_{θ i} \\ {V}_{ij 3} = {ω}_{0} {L}_{T} {i}_{fdi}^{c} cos Δ {θ}_{i} {X}_{θ j} + {L}_{T} \frac{{di}_{fdi}^{c} sin Δ {θ}_{i}}{dt} {X}_{θ j} \\ {V}_{ij 4} = - {ω}_{0} {L}_{T} {i}_{fqi}^{c} sin Δ {θ}_{i} {X}_{θ j} + {L}_{T} \frac{{di}_{fqi}^{c} cos Δ {θ}_{i}}{dt} {X}_{θ j} \\ \begin{matrix}{V}_{ij 5} = - 2 {L}_{T} ( \frac{{di}_{fdj}^{c} cos {Δθ}_{j}}{dt} {i}_{fdi}^{c} cos Δ {θ}_{i} + \frac{{di}_{fdj}^{c} sin Δ {θ}_{j}}{dt} {i}_{fdi}^{c} sin Δ {θ}_{i} + \\ \frac{{di}_{fdi}^{c} cos {Δθ}_{i}}{dt} {i}_{fdj}^{c} cos Δ {θ}_{j} + \frac{{di}_{fdi}^{c} sin Δ {θ}_{i}}{dt} {i}_{fdj}^{c} sin Δ {θ}_{j} ) \\ \begin{matrix}{V}_{ij 6} = - 2 {L}_{T} ( - \frac{{di}_{fqj}^{c} sin {Δθ}_{j}}{dt} {i}_{fdi}^{c} cos Δ {θ}_{i} + \frac{{di}_{fqj}^{c} cos Δ {θ}_{j}}{dt} {i}_{fdi}^{c} sin Δ {θ}_{i} - \\ \frac{{di}_{fdi}^{c} cos {Δθ}_{i}}{dt} {i}_{fqj}^{c} sin Δ {θ}_{j} + \frac{{di}_{fqi}^{c} sin Δ {θ}_{i}}{dt} {i}_{fqj}^{c} cos Δ {θ}_{j} ) \\ \begin{matrix}{V}_{ij 7} = - 2 {L}_{T} ( - \frac{{di}_{fqj}^{c} cos {Δθ}_{j}}{dt} {i}_{fqi}^{c} sin Δ {θ}_{i} + \frac{{di}_{fdj}^{c} sin Δ {θ}_{j}}{dt} {i}_{fqi}^{c} cos Δ {θ}_{i} - \\ \frac{{di}_{fqi}^{c} sin {Δθ}_{i}}{dt} {i}_{fdj}^{c} cos Δ {θ}_{j} + \frac{{di}_{fqi}^{c} cos Δ {θ}_{i}}{dt} {i}_{fdj}^{c} sin Δ {θ}_{j} ) \\ \begin{matrix}{V}_{ij 8} = - 2 {L}_{T} ( \frac{{di}_{fqj}^{c} sin {Δθ}_{j}}{dt} {i}_{fqi}^{c} sin Δ {θ}_{i} + \frac{{di}_{fqj}^{c} cos Δ {θ}_{j}}{dt} {i}_{fqi}^{c} cos Δ {θ}_{i} + \\ \frac{{di}_{fqi}^{c} sin {Δθ}_{i}}{dt} {i}_{fqj}^{c} sin Δ {θ}_{j} + \frac{{di}_{fqi}^{c} cos Δ {θ}_{i}}{dt} {i}_{fqj}^{c} cos Δ {θ}_{j} )\end{matrix}\end{matrix}\end{matrix}\end{matrix}\end{matrix}$$

where Vᵢⱼ₁ represents the energy flow of the energy transfer path of the phase locked loop of the i-th wind turbine generator, the current loop d axis of the i-th wind turbine generator, and the phase locked loop of the j-th wind turbine generator; Vᵢⱼ₂ represents the energy flow of the energy transfer path of the phase locked loop of the i-th wind turbine generator, the current loop q axis of the j-th wind turbine generator, and the phase locked loop of the j-th wind turbine generator; ᵢⱼ₃ represents the energy flow of the energy transfer path of the current loop d axis of the i-th wind turbine generator, the phase locked loop of the i-th wind turbine generator, and the phase locked loop of the j-th wind turbine generator; Vᵢⱼ₄ represents the energy flow of the energy transfer path of the current loop q axis of the i-th wind turbine generator, the phase locked loop of the i-th wind turbine generator, and the phase locked loop of the j-th wind turbine generator; Vᵢⱼ₅ represents the energy flow of the energy transfer path of the current loop d axis of the i-th wind turbine generator, the phase locked loop of the i-th wind turbine generator, the current loop d axis of the j-th wind turbine generator, and the phase locked loop of the j-th wind turbine generator; Vᵢⱼ₆ represents the energy flow of the energy transfer path of the current loop d axis of the i-th wind turbine generator, the phase locked loop of the i-th wind turbine generator, the current loop q axis of the j-th wind turbine generator, and the phase locked loop of the j-th wind turbine generator; Vᵢⱼ₇ represents the energy flow of the energy transfer path of the current loop q axis of the i-th wind turbine generator, the phase locked loop of the i-th wind turbine generator, the current loop d axis of the j-th wind turbine generator, and the phase locked loop of the j-th wind turbine generator; Vᵢⱼ₈ represents the energy flow of the energy transfer path of the current loop q axis of the i-th wind turbine generator, the phase locked loop of the i-th wind turbine generator, the current loop q axis of the j-th wind turbine generator, and the phase locked loop of the j-th wind turbine generator.

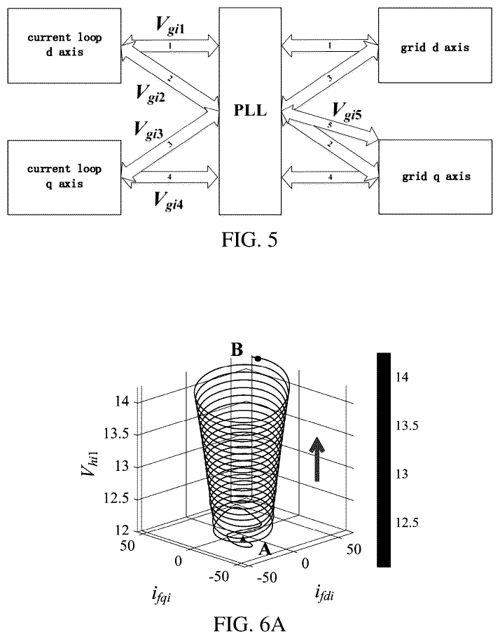

As shown in FIG. 5, the energy flows of each coupling energy transfer path obtained by dividing the generator-grid coupling paths are as follows:

$$\{ \begin{matrix}{V}_{gi 1} = - 2 {u}_{md} {i}_{f d i}^{c} cos Δ {θ}_{i} \\ {V}_{gi 2} = - 2 {u}_{mq} {i}_{f d i}^{c} sin {Δθ}_{i} \\ {V}_{g i 3} = 2 {u}_{m d} {i}_{fqi}^{c} sin {Δθ}_{i} \\ {V}_{g i 4} = - 2 {u}_{m q} {i}_{f q i}^{c} cos Δ {θ}_{i} \\ {V}_{gi 5} = {u}_{m q} {X}_{θ i}\end{matrix}$$

where V_{gi1} represents the energy flow of the energy transfer path of the current loop d axis of the i-th wind turbine generator, the phase locked loop of the i-th wind turbine generator, and the d axis of the grid; V_{gi2} represents the energy flow of the energy transfer path of the current loop d axis of the i-th wind turbine generator, the phase locked loop of the i-th wind turbine generator, and the q axis of the grid; V_{gi3} represents the energy flow of the energy transfer path of the current loop q axis of the i-th wind turbine generator, the phase locked loop of the i-th wind turbine generator, and the d axis of the grid; V_{gi4} represents the energy flow of the energy transfer path of the current loop q axis of the i-th wind turbine generator, the phase locked loop of the i-th wind turbine generator, and the q axis of the grid; V_{gi5} represents the energy flow of the energy transfer path of the phase locked loop of the i-th wind turbine generator and the q axis of the grid.

S3: According to the energy flow of the coupling energy transfer path of the direct drive wind farm in each acquisition period, the key energy transfer path of the direct drive wind farm in each acquisition period is tracked, and the stability control of the direct drive wind farm is realized.

When implemented, key energy transfer paths of direct drive wind farms are tracked by:

Based on the set time interval, the energy flow of the last acquisition period of each coupling energy transfer path of the direct drive wind farm in this time interval is subtracted from the energy flow of the first acquisition period, and the energy flow variation of each coupling energy transfer path of the direct drive wind farm in this time interval is obtained.

Based on the energy flow variation of each coupling energy transfer path of a direct drive wind farm in the set time interval, the coupling energy transfer paths with the largest energy flow variation in the energy flows of the generator internal coupling path, the generator-generator coupling path and the generator-grid coupling path are obtained respectively, and the obtained coupling energy transfer paths are taken as the key energy transfer paths of the direct drive wind farm in the time interval.

Preferably, the set time interval is two adjacent acquisition periods, and the key energy transfer path of the direct drive wind farm for each acquisition period can be obtained.

It can be understood that the coupling energy transfer path is the corresponding derivative, and the specific value of the derivative represents the increase or decrease of the energy flow of the coupling energy transfer path. By comparing the specific value of each coupling energy transfer path, that is, the increase or decrease of the energy flow, the key energy transfer path affecting the stability of the direct drive wind farm is tracked, and the key control link affecting the stability level of the system is selected out.

Further, by tracking the key energy transfer path, the adverse control link in the direct drive wind farm is defined, and the oscillation is suppressed by adding the energy compensation branch in the corresponding control link, so as to achieve the stability control of the direct drive wind farm.

Compared with the prior art, this example provides a method for tracking the oscillation path of a direct drive wind farm. By taking the dominant oscillation mode period as the acquisition period when a direct drive wind farm fails, the corresponding instantaneous value of each oscillation component is obtained by collecting data, and the energy flow of the coupling energy transfer path between subsystems of the direct drive wind farm in each acquisition period is obtained. Then, the key energy transfer path of the direct drive wind farm in each acquisition period is tracked to achieve accurate and effective tracking of the key energy transfer path of the grid-connected system of the direct drive wind farm, and guiding suggestions are given for the stable and safe operation of the power system. And by dividing the whole wind turbine generator into multiple subsystems, the key control links that affect the stability level of the system are selected out. The coupling energy transfer paths obtained by dynamic coupling energy derivatives reduce the calculation amount, improve the calculation accuracy, and ensure the reliable operation of the system.

### Example 2

A specific embodiment of the application discloses a direct drive wind farm oscillation path tracking system, which comprises:

The data acquisition module is used to collect the port current, the current and state variable of the current inner loop, the dynamic angle and state component of the phase-locked loop, and the phase and amplitude of the fault point voltage of each wind turbine generator when a direct drive wind farm fails, and then to obtain the corresponding instantaneous value of each oscillation component of the direct drive wind turbine generator.

The coupling energy transfer path acquisition module is used to obtain the energy flow of the coupling energy transfer path of the direct drive wind farm in each acquisition period based on the instantaneous value of each oscillation component collected in each acquisition period.

The key energy transfer path tracking module is used to track the key energy transfer path of the direct drive wind farm in each acquisition period according to the energy flow of the coupling energy transfer path of the direct drive wind farm in each acquisition period, and then to realize the stability control of the direct drive wind farm.

When implemented, the coupling energy transfer path acquisition module obtains the energy flow of the coupling energy transfer path between subsystems of the direct drive wind farm in each acquisition period through the following ways:

Based on the instantaneous value of each oscillation component collected in each acquisition period, the dynamic mathematical model of each subsystem of each direct drive wind turbine generator in each acquisition period is established. The subsystems include current loop d, q axis subsystems, grid-connected line d, q axis subsystems, DC voltage outer loop subsystem and phase-locked loop subsystem.

According to the dynamic mathematical model of each subsystem of each direct drive wind turbine generator in each acquisition period, the dynamic coupling energy derivative of each subsystem of each direct drive wind turbine generator is obtained, and the dynamic coupling energy derivative of each generator in each acquisition period is obtained. The corresponding value is used as the energy flow of the dynamic coupling energy transfer path of each generator in each acquisition period.

The energy flow of the dynamic coupling energy transfer path of each generator in each acquisition period is divided to obtain the energy flow of the generator internal coupling path, the generator-generator coupling path and the generator-grid coupling path. Then the energy flow of the generator internal coupling path, the generator-generator coupling path and the generator-grid coupling path is divided respectively to obtain the energy flow of each coupling energy transfer path of the direct drive wind farm in each acquisition period.

The specific implementation process of the embodiment of the application can be referred to the above method embodiment, and the embodiment will not be repeated here.

Since the principle of this embodiment is the same as that of the above method embodiments, the system also has the corresponding technical effects of the above method embodiments.

### Example 3

In order to verify the correctness and feasibility of the direct drive wind farm oscillation path tracking method and system provided by examples 1 and 2 of the application, the scheme in the above examples is tested and verified. The grid-connected system of two direct drive wind farms is built from the simulation level, and the impedance of the AC system is changed to obtain the oscillating divergence scene after the system is disturbed. The system simulation structure diagram is shown in FIG. 2. The simulation model is built on the RT-LAB platform. The parameters of grid-connected system of direct drive wind farm are shown in Table 1.

TABLE 1
Parameters of grid-connected system of direct drive wind farm

| parameter | symbol | value |
|---|---|---|
| rated power | Pₙ/MW | 1.5 |
| current loop control parameters | k_{P1} | 0.495e−3 |
| | k_{I1} | 0.121 |
| PLL control parameters | K_{Pθ} | 0.67 |
| | K_{Iθ} | 38.2 |
| grid-connected inductance | Lₓ₁, Lₓ₂/H | 0.3e−3, 0.2e−3 |
| DC voltage outer loop control | k_{Pu1} | 0.1 |
| parameters | k_{Iu1} | 10 |
| DC voltage | U_{dc}/kV | 1.2 |

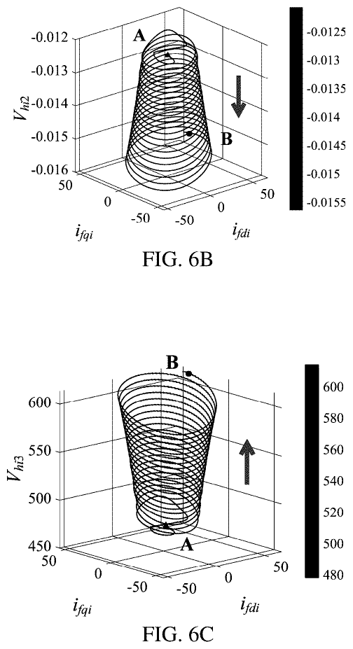

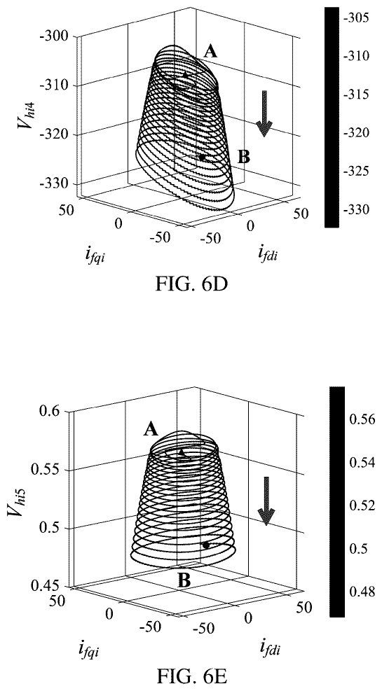

The changes of energy flows Vₕᵢ₁, Vₕᵢ₂, Vₕᵢ₃, Vₕᵢ₄ and Vₕᵢ₅ of each coupling energy transfer path within a direct drive wind turbine generator are shown in FIGS. 6A-6E, respectively. During the oscillation process, the d and q axis oscillation currents i_{fd1} and i_{fq1} of PMSG1 gradually increase, and the energy flow of each transfer path also changes. In FIGS. 6A-6E, with the development of oscillation, the energy flow spirals from locus A to locus B. Among them, the value of Vₕᵢ₁ gradually increases from 12.22 to 14.24, the value of Vₕᵢ₂ gradually decreases from −0.012 to −0.016, the value of Vₕᵢ₃ gradually increases from 482.15 to 570.06, and the value of Vₕᵢ₄ gradually decreases from −312.56 to −329.76. The value of Vₕᵢ₅ gradually decreases from 0.57 to 0.47. It can be seen that the energy flow Vₕᵢ₃ of the transfer path has the largest variation, so the coupling energy transfer path under the action of current loop d axis and PLL is the key energy path of the generator-internal coupling path, and the existing stability evaluation method verifies that it is the key factor affecting the stability of the system, which proves the correctness of the determined key energy path.

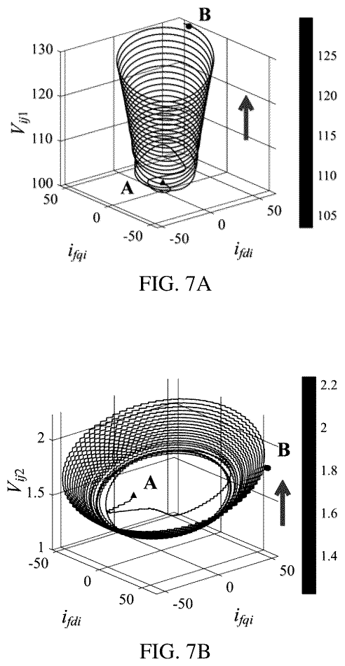

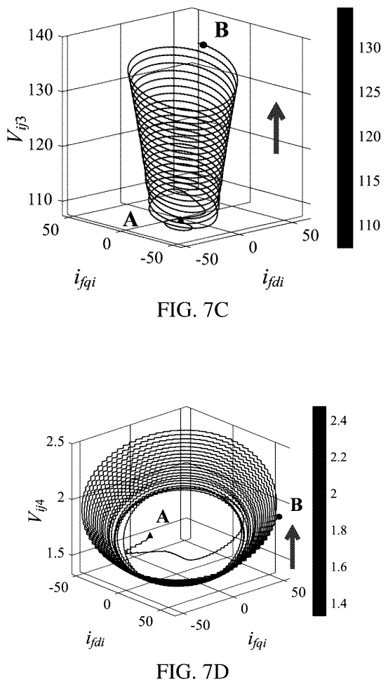

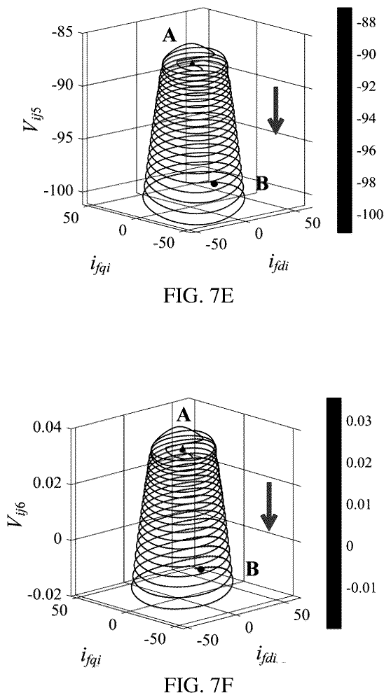

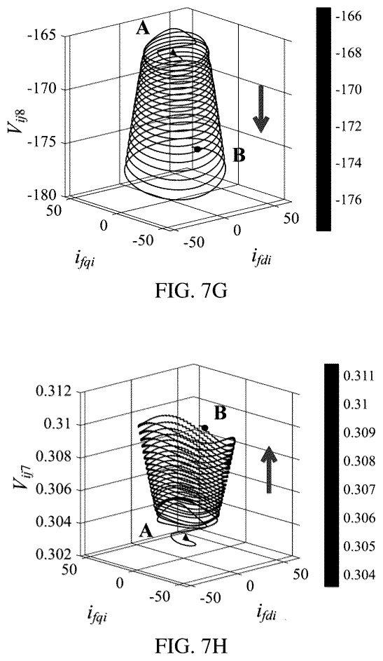

The changes of dynamic coupling energy flows Vᵢⱼ₁, Vᵢⱼ₂, Vᵢⱼ₃, Vᵢⱼ₄, Vᵢⱼ₅, Vᵢⱼ₆, Vᵢⱼ₇ and Vᵢⱼ₈ in each transfer path between PMSGi and PMSGj generators are shown in FIGS. 7A-7H respectively. As the d and q axis oscillation current i_{fd1} and i_{fq1} of PMSG1 increase gradually during the oscillation process, the dynamic coupling energy flow of each transfer path also changes. In FIGS. 7A-7H, with the development of oscillation, the energy flow spirals from locus A to locus B. Among them, the value of Vᵢⱼ₁ gradually increases from 104.11 to 129.58, the value of Vᵢⱼ₂ gradually increases from 1.49 to 1.85, the value of Vᵢⱼ₃ gradually increases from 108.01 to 133.96, and the value of Vᵢⱼ₄ gradually increases from 1.67 to 1.92. The value of Vᵢⱼ₅ gradually decreases from −87.12 to −101.18, the value of Vᵢⱼ₆ gradually decreases from 0.035 to −0.02, the value of Vᵢⱼ₇ gradually increases from 0.30 to 0.31, and the value of Vᵢⱼ₈ gradually decreases from −168.06 to −177.73. Compared with the above, it can be seen that the energy flow Vᵢⱼ₃ of the transfer path has the largest variation. Therefore, for the generator-generator coupling, the coupling transfer path between the current loop d axis of one wind turbine generator and the phase-locked loop of another wind turbine generator is the key energy transfer path of the generator-generator coupling path, and the existing stability evaluation method has verified that it is the key factor affecting the stability of the system. The correctness of the determined key energy path is proved.

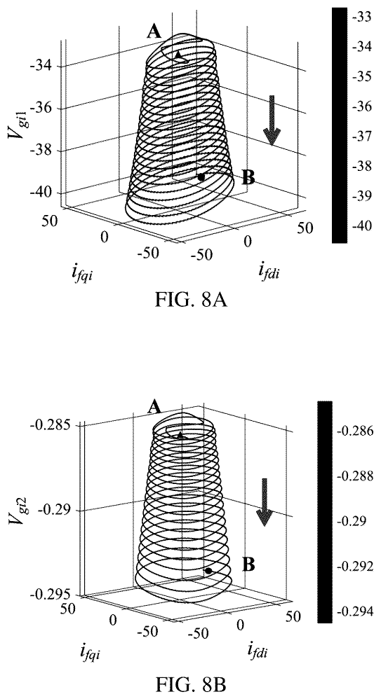

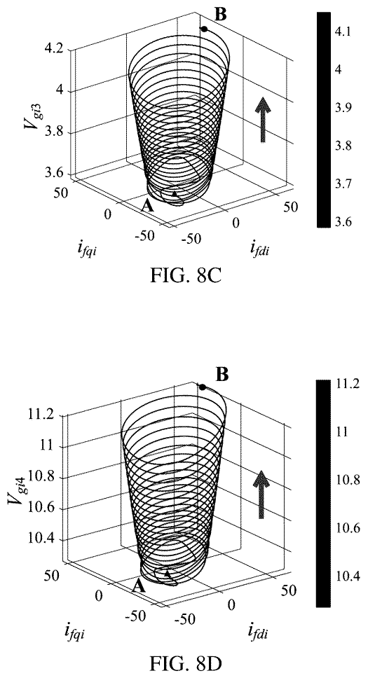

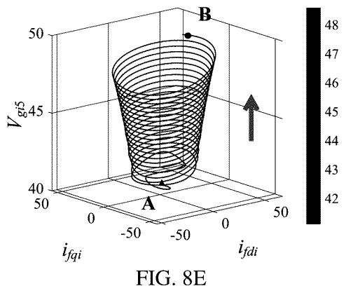

The changes of dynamic coupling energy flows V_{gi1}, V_{gi2}, V_{gi3}, V_{gi4} and V_{gi5} in each transfer path of direct drive wind turbine generators are shown in FIGS. 8A-8E, respectively. As the d and q axis oscillation current i_{fd1} and i_{fq1} of PMSG1 increase gradually during the oscillation process, the dynamic coupling energy flow of each transfer path also changes. In FIGS. 8A-8E, with the development of oscillation, the energy flow spirals from locus A to locus B. Among them, the value of V_{gi1} gradually decreases from −34.33 to −40.38, that of V_{gi2} gradually decreases from −0.28 to −0.30, that of V_{gi3} gradually increases from 3.59 to 4.15, and that of V_{gi4} gradually increases from 10.35 to 11.21. The value of V_{gi5} gradually increased from 41.16 to 48.53. It can be seen that the energy flow V_{gi5} of the transfer path has the largest variation. Therefore, for the coupling of generator and grid, the coupling transfer path between PLL and the q axis of the power grid is the key energy transfer path of the coupling path of generator and grid, and it is verified by the existing stability evaluation method that it is the key factor affecting the stability of the system, which proves the correctness of the determined key energy path.

It is understood by those skilled in the art that all or part of the process to implement the above exemplary methods may be accomplished by instructing the relevant hardware by means of a computer program that may be stored in a computer readable storage medium. The computer readable storage medium is a disk, optical disc, read-only storage memory or random storage memory, etc.

The above is only the best concrete embodiment of the invention, but the scope of protection of the invention is not limited to this, and any change or replacement that can be easily thought of by a technical person familiar with the technical field within the technical scope disclosed by the invention shall be covered by the scope of protection of the invention.

What is claimed is:

1. A method for tracking oscillation path of a direct drive wind farm, comprising:
when the direct drive wind farm failing, collecting a port current, current and state variables of a current inner loop, dynamic angle and state component of a phase-locked loop, and phase and amplitude of a fault point voltage in an acquisition period which is used as a dominant oscillation mode period, and then obtaining a corresponding instantaneous value of each oscillation component of the direct drive wind farm;
obtaining a energy flow of a coupling energy transfer path of the direct drive wind farm in each acquisition period based on the instantaneous value of each oscillation component collected in each acquisition period;
tracking a key energy transfer path of the direct drive wind farm according to the energy flow of the coupling energy transfer path of the direct drive wind farm in each acquisition period, so as to realize stability control of the direct drive wind farm.

2. The method according to claim 1, wherein the energy flow of the coupling energy transfer path between subsystems of the direct drive wind farm in each acquisition period is obtained by the following way:
establishing a dynamic mathematical model of each subsystem of each direct drive wind turbine generator in each acquisition period based on the instantaneous value of each oscillation component collected in each acquisition period, wherein the subsystems include current loop d, q axis subsystems, grid-connected line d, q axis subsystems, DC voltage outer loop subsystem and phase-locked loop subsystem;
obtaining a dynamic coupling energy derivative of each subsystem of each direct drive wind turbine generator according to the dynamic mathematical model of each subsystem of each direct drive wind turbine generator in each acquisition period, and then obtaining a dynamic coupling energy derivative of each generator in each acquisition period, a value corresponding to a dynamic coupling energy derivative of each generator in each acquisition period is used as the energy flow of the dynamic coupling energy transfer path of each generator in each acquisition period;
obtaining the energy flow of the generator internal coupling path, the generator-generator coupling path and the generator-grid coupling path by dividing the energy flow of the dynamic coupling energy transfer path of each generator in each acquisition period, then obtaining the energy flow of each coupling energy transfer path of the direct drive wind farm in each acquisition period by dividing the energy flow of the generator internal coupling path, the generator-generator coupling path, and the generator-grid coupling path.

3. The method according to claim 2, wherein tracking the key energy transfer path of the direct drive wind farm is traced in the following ways:
based on the set time interval, obtaining energy flow variation of each coupling energy transfer path of the direct drive wind farm in this time interval by subtracting energy flow of the last acquisition period of each coupling energy transfer path of the DCD wind farm in this time interval from energy flow of the first acquisition period;
based on the energy flow variation of each coupling energy transfer path of a direct drive wind farm in the set time interval, obtaining respectively the coupling energy transfer paths with the largest energy flow variation in the energy flow of the generator internal coupling path, the generator-generator coupling path and the generator-grid coupling path, and taking the coupling energy transfer paths obtained as the key energy transfer paths of the direct drive wind farm in the time interval.

4. The method according to claim 2, wherein the energy flows of each coupling energy transfer path obtained by dividing the generator internal coupling path are respectively:
$$\{ \begin{matrix}{V}_{hi 1} = {i}_{d r e f i} {u}_{kdi}^{c} cos {Δθ}_{i} \\ {V}_{hi 2} = - {i}_{d r e f i} {u}_{kqi}^{c} sin Δ {θ}_{i} \\ \begin{matrix}{V}_{hi 3} = - ( {L}_{xi} + 2 {L}_{T} ) ( \frac{d {i}_{fdi}^{c} cos {Δθ}_{i}}{d t} {i}_{fdi}^{c} cos {Δθ}_{i} + \frac{{di}_{fdi}^{c} sin {Δθ}_{i}}{d t} {i}_{fdi}^{c} sin {Δθ}_{i} ) + \\ [ {R}_{xi} {i}_{fdi}^{c} sin {Δθ}_{i} + {ω}_{0} ( {L}_{xi} + {L}_{T} ) {i}_{fdi}^{c} cos Δ {θ}_{i} + ( {L}_{xi} + {L}_{T} ) \frac{d {i}_{fdi}^{c} sin Δ {θ}_{i}}{d t} ] {X}_{θ i}\end{matrix} \\ \begin{matrix}{V}_{hi 4} = - ( {L}_{xi} + 2 {L}_{T} ) ( \frac{{di}_{fqi}^{c} cos Δ {θ}_{i}}{d t} {i}_{fqi}^{c} cos Δ {θ}_{i} + \frac{{di}_{fqi}^{c} sin Δ {θ}_{i}}{d t} {i}_{fqi}^{c} sin Δ {θ}_{i} ) + \\ [ {R}_{xi} {i}_{fqi}^{c} cos Δ {θ}_{i} - {ω}_{0} ( {L}_{xi} + {L}_{T} ) {i}_{fqi}^{c} sin Δ {θ}_{i} + ( {L}_{xi} + {L}_{T} ) \frac{{di}_{fqi}^{c} cos Δ {θ}_{i}}{d t} ] {X}_{θ i} \\ {V}_{hi 5} = - ( {L}_{xi} + 2 {L}_{T} ) ( \begin{matrix}- \frac{{di}_{fdi}^{c} cos Δ {θ}_{i}}{dt} {i}_{fqi}^{c} sin Δ {θ}_{i} - \frac{{di}_{fqi}^{c} sin {Δθ}_{i}}{dt} {i}_{fdi}^{c} cos Δ {θ}_{i} \\ + \frac{{di}_{fqi}^{c} cos Δ {θ}_{i}}{dt} {i}_{fdi}^{c} sin Δ {θ}_{i} - \frac{{di}_{fdi}^{c} sin {Δθ}_{i}}{dt} {i}_{fqi}^{c} cos Δ {θ}_{i}\end{matrix} )\end{matrix}\end{matrix}$$
Where, Vₕᵢ₁ represents energy flow of energy transfer path of the DC voltage outer loop, current loop d axis, and PLL of the i-th wind turbine generator; Vₕᵢ₂ represents energy flow of energy transfer path of DC voltage outer loop, current loop q axis, and PLL of the i-th wind turbine generator; Vₕᵢ₃ represents energy flow of energy transfer path of current loop d axis and PLL of the i-th wind turbine generator; Vₕᵢ₄ represents the energy flow of the energy transfer path of current loop q axis of the i-th wind turbine generator and the phase locked loop of the i-th wind turbine generator, and Vₕᵢ₅ represents the energy flow of energy transfer path of the current loop d axis and q axis of the i-th wind turbine generator and phase locked loop of the i-th wind turbine generator; i_{drefi} is the d-axis current reference value of the current inner loop of the i-th wind turbine generator, u_{kdi}^{c} and u_{kqi}^{c} are respectively the d and q axis components of the state variable of current inner loop of the i-th wind turbine generator under the d-q coordinate system of the control system, Δθᵢ is the dynamic angle of the phase locked loop of the i-th wind turbine generator, Rₓᵢ and Lₓᵢ are respectively the resistance and inductance of the grid-connected line of the i-th wind turbine generator, i_{fdi}^{c} and i_{fqi}^{c} are the d and q axis components of the output current of the i-th wind turbine generator under the d-q coordinate system of the control system, Lᵣ is the inductance of the transformer at the grid-connected bus bar outlet, ω₀ is the grid synchronous angular frequency, and X_{θi} is the state variable of phase locked loop of the i-th wind turbine generator.

5. The method according to claim 4, wherein the energy flows of each coupling energy transfer path obtained by dividing the generator-generator coupling paths are as follows:
$$\{ \begin{matrix}{V}_{ij 1} = {ω}_{0} {L}_{T} {i}_{fdj}^{c} cos Δ {θ}_{j} {X}_{θ i} + {L}_{T} \frac{{di}_{fdj}^{c} sin Δ {θ}_{j}}{dt} {X}_{θ i} \\ {V}_{ij 2} = - {ω}_{0} {L}_{T} {i}_{fqj}^{c} sin Δ {θ}_{j} + {L}_{T} \frac{{di}_{fqj}^{c} cos Δ {θ}_{j}}{dt} {X}_{θ i} \\ {V}_{ij 3} = {ω}_{0} {L}_{T} {i}_{fdi}^{c} cos Δ {θ}_{i} {X}_{θ j} + {L}_{T} \frac{{di}_{fdi}^{c} sin Δ {θ}_{i}}{dt} {X}_{θ j} \\ {V}_{ij 4} = - {ω}_{0} {L}_{T} {i}_{fqi}^{c} sin Δ {θ}_{i} {X}_{θ j} + {L}_{T} \frac{{di}_{fqi}^{c} cos Δ {θ}_{i}}{dt} {X}_{θ j} \\ \begin{matrix}{V}_{ij 5} = - 2 {L}_{T} ( \frac{{di}_{fdj}^{c} cos {Δθ}_{j}}{dt} {i}_{fdi}^{c} cos Δ {θ}_{i} + \frac{{di}_{fdj}^{c} sin Δ {θ}_{j}}{dt} {i}_{fdi}^{c} sin Δ {θ}_{i} + \\ \frac{{di}_{fdi}^{c} cos {Δθ}_{i}}{dt} {i}_{fdj}^{c} cos Δ {θ}_{j} + \frac{{di}_{fdi}^{c} sin Δ {θ}_{i}}{dt} {i}_{fdj}^{c} sin Δ {θ}_{j} ) \\ \begin{matrix}{V}_{ij 6} = - 2 {L}_{T} ( - \frac{{di}_{fqj}^{c} sin {Δθ}_{j}}{dt} {i}_{fdi}^{c} cos Δ {θ}_{i} + \frac{{di}_{fqj}^{c} cos Δ {θ}_{j}}{dt} {i}_{fdi}^{c} sin Δ {θ}_{i} - \\ \frac{{di}_{fdi}^{c} cos {Δθ}_{i}}{dt} {i}_{fqj}^{c} sin Δ {θ}_{j} + \frac{{di}_{fqi}^{c} sin Δ {θ}_{i}}{dt} {i}_{fqj}^{c} cos Δ {θ}_{j} ) \\ \begin{matrix}{V}_{ij 7} = - 2 {L}_{T} ( - \frac{{di}_{fqj}^{c} cos {Δθ}_{j}}{dt} {i}_{fqi}^{c} sin Δ {θ}_{i} + \frac{{di}_{fdj}^{c} sin Δ {θ}_{j}}{dt} {i}_{fqi}^{c} cos Δ {θ}_{i} - \\ \frac{{di}_{fqi}^{c} sin {Δθ}_{i}}{dt} {i}_{fdj}^{c} cos Δ {θ}_{j} + \frac{{di}_{fqi}^{c} cos Δ {θ}_{i}}{dt} {i}_{fdj}^{c} sin Δ {θ}_{j} ) \\ \begin{matrix}{V}_{ij 8} = - 2 {L}_{T} ( \frac{{di}_{fqj}^{c} sin {Δθ}_{j}}{dt} {i}_{fqi}^{c} sin Δ {θ}_{i} + \frac{{di}_{fqj}^{c} cos Δ {θ}_{j}}{dt} {i}_{fqi}^{c} cos Δ {θ}_{i} + \\ \frac{{di}_{fqi}^{c} sin {Δθ}_{i}}{dt} {i}_{fqj}^{c} sin Δ {θ}_{j} + \frac{{di}_{fqi}^{c} cos Δ {θ}_{i}}{dt} {i}_{fqj}^{c} cos Δ {θ}_{j} )\end{matrix}\end{matrix}\end{matrix}\end{matrix}\end{matrix}$$
where Vᵢⱼ₁ represents the energy flow of energy transfer path of phase locked loop of the i-th wind turbine generator, the current loop d axis of the i-th wind turbine generator, and phase locked loop of the j-th wind turbine generator; Vᵢⱼ₂ represents the energy flow of the energy transfer path of the phase locked loop of the i-th wind turbine generator, the current loop q axis of the j-th wind turbine generator, and the phase locked loop of the j-th wind turbine generator; Vᵢⱼ₃ represents the energy flow of the energy transfer path of the current loop d axis of the i-th wind turbine generator, the phase locked loop of the i-th wind turbine generator, and the phase locked loop of the j-th wind turbine generator; Vᵢⱼ₄ represents the energy flow of the energy transfer path of the current loop q axis of the i-th wind turbine generator, the phase locked loop of the i-th wind turbine generator, and the phase locked loop of the j-th wind turbine generator; Vᵢⱼ₅ represents the energy flow of the energy transfer path of the current loop d axis of the i-th wind turbine generator, the phase locked loop of the i-th wind turbine generator, the current loop d axis of the j-th wind turbine generator, and the phase locked loop of the j-th wind turbine generator; Vᵢⱼ₆ represents the energy flow of the energy transfer path of the current loop d axis of the i-th wind turbine generator, the phase locked loop of the i-th wind turbine generator, the current loop q axis of the j-th wind turbine generator, and phase locked loop of the j-th wind turbine generator; Vᵢⱼ₇ represents the energy flow of the energy transfer path of the current loop q axis of the i-th wind turbine generator, the phase locked loop of the i-th wind turbine generator, the current loop d axis of the j-th wind turbine generator, and phase locked loop of the j-th wind turbine generator; Vᵢⱼ₈ represents the energy flow of the energy transfer path of the current loop q axis of the i-th wind turbine generator, phase locked loop of the i-th wind turbine generator, the current loop q axis of the j-th wind turbine generator, and the phase locked loop of the j-th wind turbine generator; Δθⱼ is the dynamic angle of the phase locked loop of the j-th wind turbine generator, and i_{fdj}^{c} and i_{fqj}^{c} are respectively the d and q axis components of the output current of the j-th wind turbine generator under the d-q coordinate system of the control system; X_{θj} is state variable of the phase locked loop of the j-th wind turbine generator.

6. The method according to claim 5, wherein the energy flows of each coupling energy transfer path obtained by dividing the generator-grid coupling path are respectively:
$$\{ \begin{matrix}{V}_{gi 1} = - 2 {u}_{md} {i}_{f d i}^{c} cos Δ {θ}_{i} \\ {V}_{gi 2} = - 2 {u}_{mq} {i}_{f d i}^{c} sin {Δθ}_{i} \\ {V}_{g i 3} = 2 {u}_{m d} {i}_{fqi}^{c} sin {Δθ}_{i} \\ {V}_{g i 4} = - 2 {u}_{m q} {i}_{f q i}^{c} cos Δ {θ}_{i} \\ {V}_{gi 5} = {u}_{m q} {X}_{θ i}\end{matrix}$$
where V_{gi1} represents the energy flow of the energy transfer path of the current loop d axis of the i-th wind turbine generator, the phase locked loop of the i-th wind turbine generator, and the d axis of the grid; V_{gi2} represents the energy flow of the energy transfer path of the current loop d axis of the i-th wind turbine generator, the phase locked loop of the i-th wind turbine generator, and the q axis of the grid; V_{gi3} represents the energy flow of the energy transfer path of the current loop q axis of the i-th wind turbine generator, the phase locked loop of the i-th wind turbine generator, and the d axis of the power grid; V_{gi4} represents the energy flow of the energy transfer path of the current loop q axis of the i-th wind turbine generator, the phase locked loop of the i-th wind turbine generator, and the q axis of the power grid; V_{gi5} represents the energy flow of the energy transfer path of the phase locked loop of the i-th wind turbine generator and the q axis of the power grid; u_{md}and u_{mq} represent the d and q axis components of the fault point voltage respectively.

7. The method according to claim 1, wherein the dominant oscillation mode period is
$$\frac{2 π}{{ω}_{c}} ;$$
where ω_{c} represents the oscillation frequency of the dominant oscillation mode of the system.

8. The method according to claim 6, wherein the instantaneous value of each oscillation component of the direct drive wind turbine generator is expressed as:
$$\{ \begin{matrix}{i}_{f d i}^{c} = {A}_{d i} {e}^{α t} sin ( {ω}_{c} t + {φ}_{d i} ) \\ {i}_{f q i}^{c} = {A}_{q i} {e}^{α t} sin ( {ω}_{c} t + {φ}_{q i} )\end{matrix}$$
$${i}_{d r e f i} = {A}_{d r e f i} {e}^{α t} sin ( {ω}_{c} t + {φ}_{d r e f i} )$$
$${u}_{kdi}^{c} = {A}_{ukdi} {e}^{α t} sin ( {ω}_{c} t + {φ}_{ukdi} )$$
$${Δθ}_{i} = {A}_{θ i} {e}^{α t} sin ( {ω}_{c} t + {φ}_{θ i} )$$
$${X}_{θ i} = {A}_{x θ i} {e}^{α t} sin ( {ω}_{c} t + {φ}_{x θ i} )$$
$$\{ \begin{matrix}{u}_{m d} = {A}_{m d} {e}^{α t} sin ( {ω}_{c} t + {φ}_{m d} ) \\ {u}_{m q} = {A}_{m q} {e}^{α t} sin ( {ω}_{c} t + {φ}_{m q} )\end{matrix}$$
where A_{di} and A_{qi} respectively represent the amplitude of d and q axis components of the output current of the i-th wind turbine generator, α is the system damping coefficient, ω_{c} is the oscillation frequency under the d-q coordinate system of the control system, φ_{di} and φ_{qi} respectively represent the phase of d and q components of the output current of the i-th wind turbine generator, and A_{drefi} represents the amplitude of the d-axis current reference value of the current inner loop of the i-th wind turbine generator; φ_{drefi} is the phase of the d-axis current reference value of the current inner loop of the i-th wind turbine generator, A_{ukdi} is the amplitude of the d-axis component of state variable of the current inner loop of the i-th wind turbine generator, φ_{ukdi} is the phase of the d-axis component of state variable of the current inner loop of the i-th wind turbine generator, A_{θi} is the amplitude of the dynamic angle of the phase locked loop of the i-th wind turbine generator, and φ_{θi} is the phase of the dynamic angle of the phase locked loop of the i-th wind turbine generator; A_{xθi} is the amplitude of state variable of the phase locked loop of the i-th wind turbine generator, φ_{xθi} is the phase of state variable of the phase locked loop of the i-th wind turbine generator, A_{md} and A_{mq} are respectively the amplitudes of the d and q axis components of the fault point voltage, and φ_{md} and φ_{mq} are the phases of the d and q axis components of the fault point voltage respectively.

9. A system for tracking oscillation path of a direct drive wind farm, comprising:
a data acquisition module, configured to collect port current, current and state variable of current inner loop, the dynamic angle and state component of phase-locked loop, and phase and amplitude of fault point voltage of each wind turbine generator in an acquisition period which is used as a dominant oscillation mode period when the direct drive wind farm fails, and then to obtain the corresponding instantaneous value of each oscillation component of the direct drive wind turbine generator;
a coupling energy transfer path acquisition module, configured to obtain the energy flow of the coupling energy transfer path of the direct drive wind farm in each acquisition period based on the instantaneous value of each oscillation component collected in each acquisition period;
a key energy transfer path tracking module, configured to track the key energy transfer path of the direct drive wind farm according to the energy flow of the coupling energy transfer path of the direct drive wind farm in each acquisition period, so as to realize the stability control of the direct drive wind farm.

10. The system according to claim 9, wherein the coupling energy transfer path acquisition module obtains the energy flow of the coupling energy transfer path between subsystems of the direct drive wind farm in each acquisition period through the following ways:
based on the instantaneous value of each oscillation component collected in each acquisition period, the dynamic mathematical model of each subsystem of each direct drive wind turbine generator in each acquisition period is established, wherein the subsystems include current loop d, q axis subsystems, grid-connected line d, q axis subsystems, DC voltage outer loop subsystem and phase-locked loop subsystem;
according to the dynamic mathematical model of each subsystem of each direct drive wind turbine generator in each acquisition period, the dynamic coupling energy derivative of each subsystem of each direct drive wind turbine generator is obtained, and the dynamic coupling energy derivative of each generator in each acquisition period is obtained;
the value corresponding to the dynamic coupling energy derivative of each generator in each acquisition period is used as the energy flow of the dynamic coupling energy transfer path of each generator in each acquisition period;
the energy flow of the dynamic coupling energy transfer path of each generator in each acquisition period is divided to obtain the energy flow of the generator internal coupling path, the generator-generator coupling path and the generator-grid coupling path, then the energy flow of the generator internal coupling path, the generator-generator coupling path and the generator-grid coupling path is divided respectively to obtain the energy flow of each coupling energy transfer path of the direct drive wind farm in each acquisition period.
